(19) United States
(12) Patent Application Publication
(10) Pub. No.: US 2009/0102923 A1
(43) Pub. Date: Apr. 23, 2009

(54) Truck security system

(76) Inventor: Edward L. Mason, Phoenix, AZ (US)

Correspondence Address: GALLAGHER & KENNEDY, P. A., 2575 E. CAMELBACK RD. #1100, PHOENIX, AZ, 85016, US

(21) Appl. No.: 12/284,653

(22) Filed: Sep. 23, 2008

Related U.S. Application Data
(60) Provisional application No. 60/995,172, filed on Sep. 24, 2007.

(51) Int. Cl. H04N 7/18

(52) U.S. Cl. 348/148; 701/35

(57) ABSTRACT

There is provided a truck security system for use with a truck and cab combination wherein the security system comprises: a first digital camera positioned on the truck cab and oriented so as to view toward the front of the truck; a second digital camera positioned on the truck cab and oriented so as to view toward the left of the truck cab; a third digital camera positioned on the truck cab and oriented so as to view toward the right of the truck cab; a fourth digital camera positioned on the truck cab and oriented so as to view toward the rear of the truck cab; a fifth digital camera positioned on the truck trailer and oriented so as to view toward the rear of the truck trailer; a first microphone positioned proximate to the truck cab; a second microphone positioned proximate the rear of the truck trailer; a control unit linked to each of the first camera, the second camera, the third camera, the fourth camera, the fifth camera, the first microphone, and the second microphone. The control unit may further be linked to a DVR for recording information from any of the cameras and microphones. Additionally, the DVR recorder can receive information from truck systems such as engine RPM, engine temperature, speed, gear selection, and brake status.

### FIELD OF THE INVENTION

The present invention relates to trucks. More particularly, the invention relates to video-assisted security systems for use with trucks and similar vehicles.

### BACKGROUND OF THE INVENTION

Trucking and carriage of goods by truck is a significant segment of the US transportation industry. Trucks often carry loads that can be associated with a high level of insurance or liability risk. For example, high value items such as electronics, pharmaceuticals, liquor, and food stuffs are particularly prone to theft. Dangerous items such as petroleum, chemicals, and fertilizers are inherently risky loads in themselves in that a collision or accident can lead to the harmful release of the materials in the load. Such kinds of loads are further considered to be likely targets for attack or hijack by terrorist agents. It would thus be desired to provide a security system that can deter theft. It would also be desired to install a security system on a truck that provides real time video images of the truck environment and operation.

Expensive or high value items carried by truck, when subject to casualty, can lead to insurance claims. Frequently the loss is absorbed by the driver's insurance carrier, which can lead to increased insurance costs for the driver. Insurance premiums and deductibles can be a significant cost for businesses that run a fleet of trucks. Often, however, outside agents may be responsible for the loss when, for example, a collision or vandalism is involved. In such cases, subrogation or offset claims may exist that can offset insurance costs. However, with current technology it can be difficult and costly to establish a third party's responsibility. It would thus be desired to provide a form of evidence that demonstrates the nature of the casualty and how the loss occurred in order to clarify legal responsibility and assist in resolving insurance claims.

Another area of cost and liability in trucking operations relates to loading and unloading operations. In a common example, a truck trailer is positioned at a loading dock, the rear doors of the trailer are opened, and material is loaded onto the truck trailer through the rear doors. Often this occurs at a warehouse, and a fork lift or other motorized vehicle may move the material from the warehouse into the truck trailer. Similarly, when a truck is unloaded, the truck is often positioned at a loading dock, and a forklift removes goods and materials from the trailer and carries them into the warehouse. To cite another example, construction-related items, machinery, or goods are off loaded from the truck at a construction site, and the offloading zone or area at a construction site can often be somewhat irregularly shaped. Hence, construction-related loads are subject to a high level of damage. Often when goods are damaged there can be an issue as to whether the responsibility lay with the warehouse or other receiver, or with the truck operator. It would be desired to provide a means of easily recording loading and offloading operations in order to help ascertain responsibility for damaged goods.

Present trucking systems exist that provide positional information via GPS (global positioning system or satellite). In such systems a GPS unit is typically installed in or near the truck cab. The GPS unit provides a signal to a base or receiver that indicates the location of the truck within a degree of resolution offered by the particular GPS system. Such existing systems can provide data as to the location of the truck and whether the truck is moving or stationary. However, such GPS systems cannot provide visual or audio information related to the truck and its environment.

Additionally, video recording machines and systems are known in the art. A driver or truck operator certainly can use a hand-held video recording device to record trucking activities. However, a hand held system could not be used safely by the driver while the truck is in motion; and hand held systems suffer in that they can only record what is visible to the camera operator. Further operator-controlled video recorders obviously require the presence of an operator to record information. Thus, the use of presently known video recording devices suffers from several shortcomings when applied to the trucking industry. In a first example, it would be desired to provide for the recording of visual and audio information while the truck is in operation and being driven. It would also be desired to provide a recording means that can record information around the truck environment at night or during those times when the driver/operator is away from the truck. Additionally, it would be desired to record information around the truck environment at several locations at the same time.

Hence there has been identified a need to provide an improved truck security system. It would be desired to provide an improved truck security system that can deter theft by providing real time images of the truck environment. It would further be desired to provide a truck security system that provides information for casualty issues by recording real time images of the truck environment. It is further desired to provide a truck security system that can record and provide information both when the truck is in motion and when stationary; and additionally it would be desired to provide a truck security system that can record and provide information regardless whether the operator is present or not present. The embodiments of the present invention disclosed herein address one or more of these long felt but unmet needs.

### SUMMARY OF THE INVENTION

In a first embodiment, by way of example only, there is provided a truck security system for use with a truck and cab combination wherein the security system comprises: a first digital camera positioned on the truck cab and oriented so as to view toward the front of the truck; a second digital camera positioned on the truck cab and oriented so as to view toward the left of the truck cab; a third digital camera positioned on the truck cab and oriented so as to view toward the right of the truck cab; a fourth digital camera positioned on the truck cab and oriented so as to view toward the rear of the truck cab; a fifth digital camera positioned on the truck trailer and oriented so as to view toward the rear of the truck trailer; a first microphone positioned proximate to the truck cab; a second microphone positioned proximate the rear of the truck trailer; a control unit linked to each of the first camera, the second camera, the third camera, the fourth camera, the fifth camera, the first microphone, and the second microphone. The control unit may further be linked to a DVR for recording information from any of the cameras and microphones. Additionally, the DVR recorder can receive information from truck systems such as engine RPM, engine temperature, speed, gear selection, and brake status.

In a second embodiment, still by way of example only, there is provided a method for monitoring activity in the area surrounding a truck having a cab and a trailer so as to define a front area, a rear area, a left area, and a right area. The method includes the steps of viewing the front area of the truck through a first digital camera, viewing the left area of the truck through a second digital camera, viewing the rear area of the truck through a third digital camera, and viewing the right area of the truck through a third digital camera. The method may also include steps of receiving audio information from a first microphone positioned proximate to the truck cab; and receiving audio information from a second microphone positioned proximate to the rear of the truck trailer. The information provided by the first digital camera, the second digital camera, the third digital camera, the fourth digital camera, the first microphone, and the second microphone can be directed to a control unit positioned in the truck cab where the truck operator can easily control each of these units as well as listen to the audio feed and view the video feed on a monitor. The control unit can also record and store this information for later access.

### BRIEF DESCRIPTION OF THE DRAWINGS

FIG. 1 is a top view of a truck showing a truck security system layout, according to an embodiment of the present invention;

FIG. 2 is a schematic view of a truck security system, according to an embodiment of the present invention;

FIG. 3 is a further schematic view of a truck security system, according to an embodiment of the present invention;

FIG. 4 is an additional schematic view of a truck security system, according to an embodiment of the present invention; and

FIG. 5 is a top view of a truck showing an additional truck security system layout, according to an embodiment of the present invention;

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

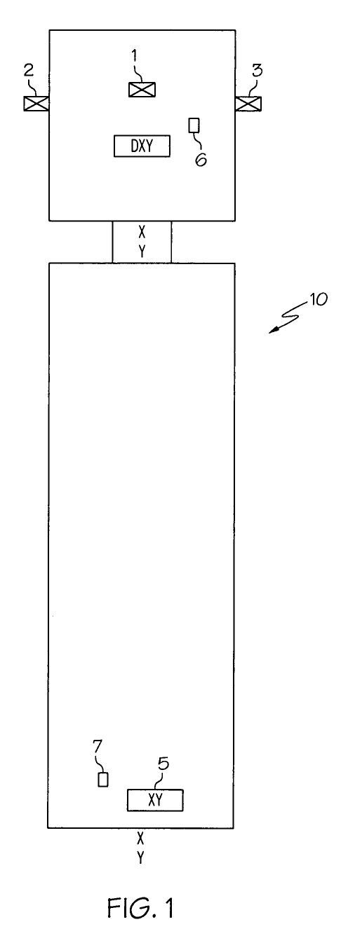

Referring initially to FIG. 1, there is shown an exemplary system layout, according to a preferred embodiment of the invention. In a preferred embodiment, the security system 10 comprises digital cameras, audio receivers, a control unit, and an audio/video data storage. Optionally, the system can include hardware to transmit audio/video data by wireless communication. Additionally, the system can include links between various engine controls and the control unit, such as, for example, links providing information for engine RPM, gear selection, vehicle surface speed, tire pressure, engine temperature, oil pressure, fuel level, brake sensor information, and the like. Further, the system can also include a monitor or visual display to provide information to the truck driver/operator.

Any number of cameras can be used in the system. In one embodiment, the system includes a first camera 1 positioned in the truck cab that generally captures images oriented toward the front of the truck. The camera can be mounted using known bracketing materials from the cab roof (interior or exterior) or the cab dash. The front camera is thus advantageously positioned so as to capture images of the road and traffic ahead of the truck, the region into which the truck moves when going forward. A second camera 2 is mounted and positioned so as to capture images toward the left of the cab, and a third camera 3 is mounted and positioned so as to capture images toward the right of the cab. The second and third cameras are advantageously positioned to capture images showing the road and traffic to the left and right of the cab, respectively. Further, when the truck makes a left hand turn, the second camera can show that region into which the truck will generally turn. Similarly, when the truck makes a right hand turn, the third camera can show that region into which the truck will generally turn. If desired, the second and third cameras (or additional cameras) can be oriented so as pan down the length of the cab and trailer. Thus, the second and third cameras, positioned in the cab area, can also show activity (proceeding rearward from the cab) that occurs along the length of the truck and cab. The second and third cameras can be mounted on any suitable structure such as the interior or exterior of the cab roof. A fourth camera 4 can be positioned so as to view the region behind the truck cab. This camera can capture images of the area between the cab and the trailer when a trailer is attached to the cab; otherwise the capture can capture images oriented in a generally rearward position relative to the cab when, for example, no trailer is attached to the cab.

Optionally, cameras may also be positioned on the trailer. In one embodiment, a fifth camera 5 can be positioned at the rear end of the trailer so as to capture images directed in a generally rearward position relative to the trailer. This camera can thus show traffic that approaches the trailer from the rear position. The camera can also be useful to show activities during loading and unloading operations that take place at the rear of the trailer. In other embodiments (not shown), the system can include cameras positioned at the rear corners of the trailer, with each camera viewing a quadrant (or other section) of activity relative to the truck. Other cameras can be positioned on the sides of the trailer to view information at those locations.

In addition to cameras, the system can also include audio receivers such as microphones. In a preferred embodiment, a first microphone 6 is positioned in the cab area, and a second microphone 7 is positioned toward the rear of the trailer. Preferably, the microphones are positioned so as to record sound information from the exterior of the truck; however, any microphone may also be positioned so as to record sounds from the interior of the truck.

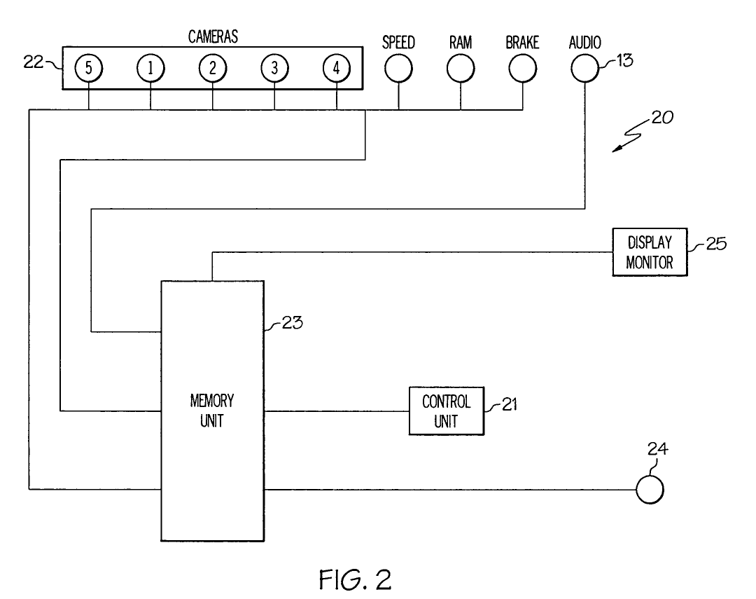

Referring next to FIG. 2 there is shown an exemplary schematic of system linkages 20. The cameras and microphones are linked to the control unit 21. The linkage allows the video and audio information received at the cameras 22 and microphones 13 to be transmitted to the control unit 21. When received at the control unit, the video and audio data, preferably in digital form, can be further processed. In one embodiment, the information is transmitted to a display monitor 25 positioned in the truck cab. The display monitor allows the driver/operator to view images from the cameras. In a further embodiment, a memory unit 23 is connected to the control unit 21. Video and audio data is directed to the memory unit where it is stored. In a further embodiment, wireless transmission hardware 24 is linked to the control unit. The video and audio data can be directed to the wireless transmission unit for broadcast by wireless signal. In this manner, the truck security system can transmit real time video and audio data from the truck to a base where the information is received.

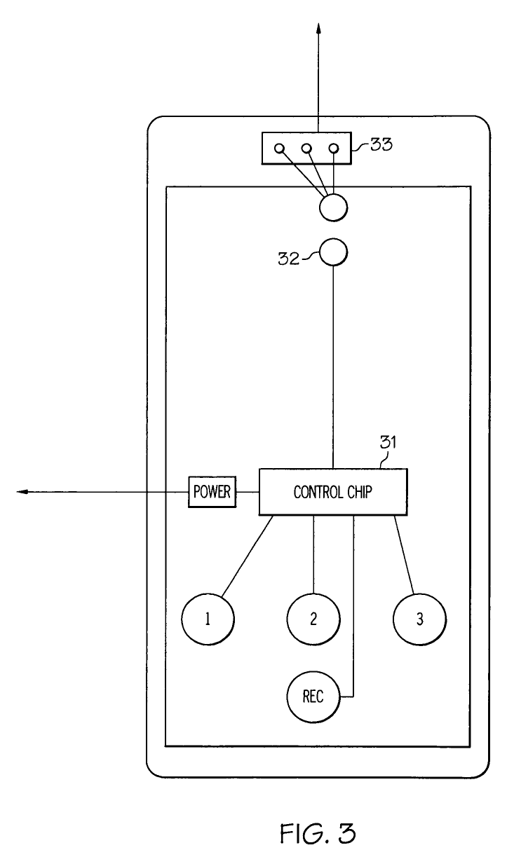

Referring next to FIG. 3 there is shown an exemplary embodiment of how the truck security system may include IR receivers and transmitters in its configuration. In the illustrated preferred embodiment, individual cameras 1, 2, and 3 have their signals routed through an IR control chip 31. The IR control chip sends data through an IR transmitter 32. The IR signal is then received at an IR receiver 33, and that signal in turn is sent to a DVR. A record control switch is advantageously positioned so as to cooperate with the IR control chip. Additionally, each camera 1, 2, and 3 can be activated through switches also connected to the IR control chip. In this manner, a signal control panel allows a human operator to select a camera for activation as well as select whether the signal from that camera is to be sent to a DVR for recording. Power can be directed to the IR control chip through a power switch as noted in FIG. 3.

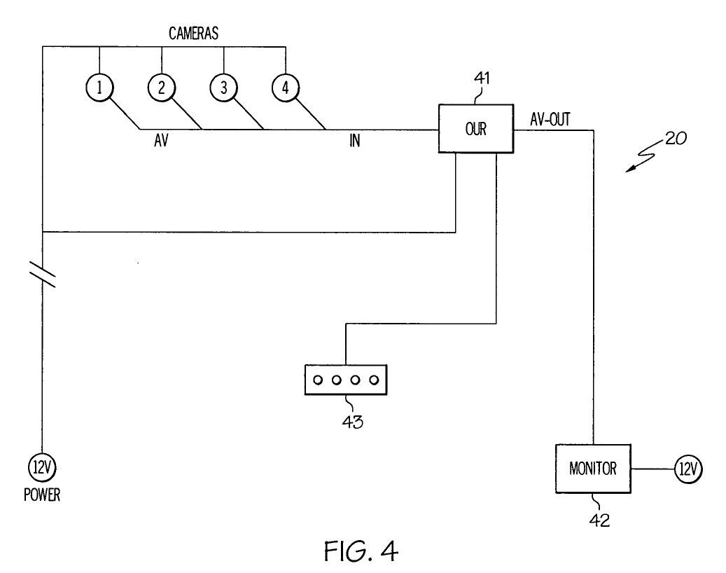

Referring now to FIG. 4 there is illustrated an alternative embodiment for monitoring and controlling the truck security system. In this alternate embodiment, each of cameras 1, 2, 3, and 4 are powered by a common source (though separate power is also acceptable). The signal from each of the cameras is then directed by cable to a DVR 41. One output of the DVR is directed to a monitor 42. The monitor can advantageously be positioned in the truck cab for viewing by the truck driver/operator. Additionally, a switch 43 is linked by cable to the DVR. A switch panel, preferably located in the truck cab, allows the driver/operator to make input control selections such as power on/off, recording by the DVR, and selection of a particular camera. Thus, for example, the driver/operator, if he wishes to view camera 1 can make that selection at the switch panel. The image from camera 1 is then displayed at the monitor. If the image from camera 2 is next desired, the driver can prompt the switch for camera 2, the system then displays from that camera on the monitor. In a similar manner, the driver/operator can record camera information by making the record selection. It is further within the scope of the present invention to record more than one camera signal simultaneously at the DVR. Thus, for example, though the monitor may only display a single camera, the DVR can record more than one camera image.

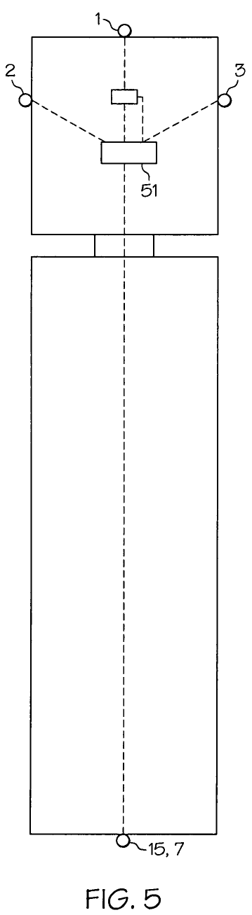

Referring next to FIG. 5, there is shown an exemplary schematic layout of how the components in FIG. 3 or FIG. 4 may be positioned in a truck. For example, cameras 1, 2, and 3 can be positioned at the left, front, and right of the exterior of the truck cab. A fourth camera can be positioned at the rear exterior of the truck trailer. The monitor 51 can be positioned in the interior of the truck cab; preferably the monitor should be positioned so that it can be viewed by the driver/operator when seated in the normal and customary driving position. The DVR is preferably positioned in the interior of the truck cab so as to protect it from exterior weather. However, the DVR need not necessarily be positioned so that it is within arm's length reach of the driver. Rather, the DVR can be positioned in a more remote, space-saving position. In the preferred embodiment, a control panel or control switch as previously described would be positioned in some place proximate to the driver, and the driver controls operation of the system through that control panel.

In operation, the truck security system is advantageously used in numerous situations. For example, when there's been an accident, the system provides useful information for accident reconstruction. The system can show data such as engine RPM, vehicle speed, gear selection, and brake activity. Further, the system provides visual and audio information of how the accident took place. The security system thus allows a reenactment or recreation of the vehicle operation and control at the time of the accident, spill, wreck, or whatever incident occurred. The system could thus provide evidence to help bolster a driver's assertion that he was not negligent or at fault.

Similarly, the system could be used to record information during loading and unloading operations. During these loading and unloading operations damage to goods can occur. This is a relatively large expensive in the trucking industry. The camera can record loading and unloading operations. Thus, for example, if the forklift damaged the goods during the loading operation, that can be recorded. This will help to counter a later accusation that damage occurred due to some negligence of the driver.

Certain loads carried by truck are characterized as high theft loads. Examples of high theft loads include pharmaceuticals, electronics, groceries, and liquor. This security system again can provide evidence of theft that is useful for resolving insurance claims.

Further, it is noted that the data passing through the truck security system can be uploaded/downloaded. Thus, for example, by an appropriate wireless transmission link the system data could be transmitted from the truck to a home base. In this manner a fleet of trucks can be monitored at a central fleet management location. Additionally, government security agencies could be authorized to access the data. Thus, in any incident involving a sensitive load such as, for example, fertilizer loads or hazardous materials, government security agencies can quickly receive live information from the truck by accessing the truck security system data. In contrast, presently available truck security systems, such as the Qualcomm GPS system, can provide location data; the present systems, however, cannot provide live visual pictures of activities in and around the truck. The present system can do that.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A truck security system for a truck including a cab and a trailer and wherein the truck defines a front area, a left area, a right area, and a rear area, the security system comprising:
a first digital camera positioned on the truck cab and oriented so as to view toward the front area of the truck;
a second digital camera positioned on the truck cab and oriented so as to view toward the left area of the truck cab;
a third digital camera positioned on the truck cab and oriented so as to view toward the right area of the truck cab;
a fourth digital camera positioned on the truck cab and oriented so as to view toward the rear area of the truck cab;
a fifth digital camera positioned on the truck trailer and oriented so as to view toward the rear area of the truck trailer;
a first microphone positioned proximate to the truck cab;
a second microphone positioned proximate the rear of the truck trailer; and
a control unit linked to each of the first camera, the second camera, the third camera, the fourth camera, the fifth camera, the first microphone, and the second microphone.

2. The truck security system according to claim 1 further comprising a vehicle sensor and a digital information link between the control unit and the vehicle sensor so as to provide to the control unit information selected from the group consisting of engine RPM, vehicle speed, gear selection, engine temperature, oil pressure, fuel level, and brake information.

3. The truck security system according to claim 1 further comprising a display monitor positioned in the truck cab and linked to the control unit so as to display information related to the digital cameras or the microphones.

4. The truck security system according to claim 1 further comprising wireless transmission hardware linked to the control unit.

5. The truck security system according to claim 4 wherein the wireless transmission hardware transmits video images from the cameras and audio information from the microphones.

6. The truck security system according to claim 1 further comprising a memory unit connected to the control unit.

7. The truck security system according to claim 6 wherein the memory unit includes video information from the cameras.

8. The truck security system according to claim 6 wherein the memory unit includes audio information from the cameras and microphones.

9. The truck security system according to claim 1 further comprising a selector linked to the display monitor so as to control which camera image is displayed on the display monitor.

10. A truck security system for a truck including a cab and a trailer having a front area, a left area, a right area, and a rear area, the security system comprising:
a first digital camera positioned on the truck cab and oriented so as to view toward the front area of the truck;
a second digital camera positioned on the truck cab and oriented so as to view toward the left area of the truck cab;
a third digital camera positioned on the truck cab and oriented so as to view toward the right area of the truck cab;
a fourth digital camera positioned on the truck cab and oriented so as to view toward the rear area of the truck cab;
a fifth digital camera positioned on the truck trailer and oriented so as to view toward the rear area of the truck trailer;
a first microphone positioned proximate to the truck cab;
a second microphone positioned proximate the rear of the truck trailer;
a control unit linked to each of the first camera, the second camera, the third camera, the fourth camera, the fifth camera, the first microphone, and the second microphone; and
a vehicle sensor and a digital information link between the control unit and the vehicle sensor so as to provide to the control unit information selected from the group consisting of engine RPM, vehicle speed, gear selection, engine temperature, oil pressure, fuel.

11. The truck security system according to claim 10 further comprising a display monitor positioned in the truck cab and linked to the control unit so as to display information related to the digital cameras or the microphones.

12. The truck security system according to claim 10 further comprising wireless transmission hardware linked to the control unit.

13. The truck security system according to claim 12 wherein the wireless transmission hardware transmits video images from the cameras and audio information from the microphones.

14. The truck security system according to claim 10 further comprising a memory unit connected to the control unit.

15. The truck security system according to claim 14 wherein the memory unit includes video information from the cameras.

16. The truck security system according to claim 14 wherein the memory unit includes audio information from the cameras and microphones.

17. The truck security system according to claim 10 further comprising a selector linked to the display monitor so as to control which camera image is displayed on the display monitor.

18. A method for monitoring activity in the area surrounding a truck having a cab and a trailer so as to define a front area, a rear area, a left area, and a right area, the method comprising the steps of:
viewing the front area of the truck through a first digital camera;
viewing the left area of the truck through a second digital camera;
viewing the rear area of the truck through a third digital camera; and
viewing the right area of the truck through a third digital camera.

19. The method according to claim 18 further comprising the step of:
receiving audio information from a first microphone positioned proximate to the truck cab; and
receiving audio information from a second microphone positioned proximate to the rear of the truck trailer.

20. The method according to claim 19 further comprising the step of:
controlling the information provided by the first digital camera, the second digital camera, the third digital camera, the fourth digital camera, the first microphone, and the second microphone by a control unit positioned in the truck cab.
